(19) United States
(12) Patent Application Publication
(10) Pub. No.: US 2024/0297428 A1
(43) Pub. Date: Sep. 5, 2024

(54) LIQUID CRYSTAL PHASE SHIFTER AND METHOD FOR OPERATING THE LIQUID CRYSTAL PHASE SHIFTER, AND ANTENNA

(71) Applicant: BOE Technology Group Co., Ltd., Beijing (CN)

(72) Inventors: Zhao CUI, Beijing (CN); Zhonglan ZHAO, Beijing (CN); Feng ZHANG, Beijing (CN); Wenqu LIU, Beijing (CN); Zhijun LV, Beijing (CN); Liwen DONG, Beijing (CN); Detian MENG, Beijing (CN); Dongfei HOU, Beijing (CN); Yuqiao LI, Beijing (CN); Mengya SONG, Beijing (CN); Guoteng LI, Beijing (CN); Feng QU, Beijing (CN)

(73) Assignee: BOE Technology Group Co., Ltd., Beijing (CN)

(21) Appl. No.: 18/663,144

(22) Filed: May 14, 2024

Related U.S. Application Data
(63) Continuation of application No. PCT/CN2023/075995, filed on Feb. 14, 2023.

(51) Int. Cl. H01P 1/18; G02F 1/133; G02F 1/1343; H01Q 3/38

(52) U.S. Cl. CPC H01P 1/18; G02F 1/13306; G02F 1/134309; H01Q 3/38

(57) ABSTRACT

The present disclosure relates to a liquid crystal phase shifter, a method for operating the liquid crystal phase shifter and an antenna. The liquid crystal phase shifter includes a first substrate, a second substrate, a liquid crystal layer and at least one adjustment unit. The one of the at least one adjustment unit includes a first electrode, a second electrode and a control circuit. The control circuit comprises a driving sub-circuit, a switching sub-circuit and a reset sub-circuit. The driving sub-circuit is configured to input a voltage to the first electrode. The reset sub-circuit is configured reset a voltage of a control terminal of the driving sub-circuit.

### CROSS-REFERENCE TO RELATED APPLICATION

The present application is a continuation of International Application No. PCT/CN2023/075995, filed on Feb. 14, 2023, the contents of which are incorporated herein by reference in its entirety for all purposes.

### TECHNICAL FIELD

The present disclosure relates to the display technical field, and specifically to a liquid crystal phase shifter, a method for operating the liquid crystal phase shifter, and an antenna.

### BACKGROUND

A liquid crystal phase shifter changes the dielectric constant of the liquid crystal material by adjusting an applied voltage on a first electrode, causing the phase constant of the electromagnetic wave on a device to change, and ultimately achieving the effect of adjusting an amount of phase shift.

Currently, in the procedure of adjusting an applied voltage, a set voltage which is to be applied is directly input on first electrodes, this may cause deviations between actual applied voltages on different first electrodes and the set voltage, which thus leads to poor control accuracy of the amount of phase shift.

It should be noted that the information disclosed in the background section is only used to enhance understanding of the background of the present disclosure, and therefore may include information that does not constitute prior art known to those of ordinary skill in the art.

### SUMMARY

According to an aspect of the present disclosure, there is provided a liquid crystal phase shifter. The liquid crystal phase shifter includes: a first substrate, a second substrate, a liquid crystal layer and at least one adjustment unit. The second substrate is arranged opposite to the first substrate. The liquid crystal layer is arranged between the first substrate and the second substrate. The adjustment unit includes a first electrode, a second electrode and a control circuit. The first electrode is arranged at a side of the first substrate close to the second substrate. The second electrode is arranged at a side of the second substrate close to the first substrate. An orthographic projection of the second electrode on the first substrate partially overlaps an orthographic projection of the first electrode on the first substrate, and the second electrode is grounded. The control circuit is arranged between the first substrate and the first electrode, and the control circuit includes a driving sub-circuit, a switching sub-circuit and a reset sub-circuit. The driving sub-circuit is configured to input an applied voltage to the first electrode, the switching sub-circuit is configured to control on or off of the driving sub-circuit, and the reset sub-circuit is configured reset a voltage of a control terminal of the driving sub-circuit.

In an embodiment of the present disclosure, an input terminal of the driving sub-circuit is connected to a power signal line, an output terminal of the driving sub-circuit is connected to the first electrode, and the control terminal of the driving sub-circuit is connected to an output terminal of the switching sub-circuit;
an input terminal of the switching sub-circuit is connected to a data signal line, a control terminal of the switching sub-circuit is connected to a data signal control line; and
the control terminal of the driving sub-circuit is connected to an output terminal of the reset sub-circuit, an input terminal of the reset sub-circuit is connected to a reset signal line, and a control terminal of the reset sub-circuit is connected to a reset signal control line.

In an embodiment of the present disclosure, the liquid crystal phase shifter includes a plurality of the adjustment units.

In an embodiment of the present disclosure, the driving sub-circuit includes a third transistor, the input terminal of the driving sub-circuit is a source electrode of the third transistor, the output terminal of the driving sub-circuit is a drain electrode of the third transistor, and the control terminal of the driving sub-circuit is a gate electrode of the third transistor;
the switching sub-circuit includes a second transistor, the input terminal of the switching sub-circuit is a source electrode of the second transistor, the output terminal of the switching sub-circuit is a drain electrode of the second transistor, and the control terminal of the switching sub-circuit is a gate electrode of the second transistor; and
the reset sub-circuit includes a first transistor, the input terminal of the reset sub-circuit is a source electrode of the first transistor, the output terminal of the reset sub-circuit is a drain electrode of the first transistor, and the control terminal of the reset sub-circuit is a gate electrode of the first transistor.

In an embodiment of the present disclosure, the plurality of the adjustment units are arranged in a rectangular array;
gate electrodes of first transistors of two control circuits located in a same row are connected to a same reset signal control line;
gate electrodes of second transistors of two control circuits located in a same row are connected to a same data signal control line;
source electrodes of first transistors of two control circuits located in a same column are connected to a same reset signal line;
source electrodes of second transistors of two control circuits located in a same column are connected to a same data signal line; and
source electrodes of third transistors of two control circuits located in a same column are connected to a same power signal line.

In an embodiment of the present disclosure, a material of an active portion of the third transistor is low-temperature polysilicon, and materials of an active portion of the first transistor and an active portion of the second transistor are IGZO oxide.

In an embodiment of the present disclosure, the control circuit includes a first transistor layer and a second transistor layer;
the first transistor layer is arranged at a side of the first substrate, where the first transistor layer includes a first active layer, a first gate insulating layer and a first gate layer sequentially arranged in a direction away from the first substrate, the first active layer includes an active portion of the third transistor, and the first gate layer includes the gate electrode of the third transistor; and
the second transistor layer is arranged at a side of the first transistor layer away from the first substrate, the second transistor layer includes a second active layer, a second gate insulating layer and a second gate layer, the second active layer includes an active portion of the first transistor and an active portion of the second transistor, and the second gate layer includes the gate electrode of the first transistor and the gate electrode of the second transistor.

In an embodiment of the present disclosure, the control circuit further includes a first conductive layer, the first conductive layer is arranged at a side of the second transistor layer away from the first substrate, the first conductive layer includes the source electrode and the drain electrode of the first transistor, the source electrode and the drain electrode of the second transistor, and the source electrode and the drain electrode of the third transistor.

In an embodiment of the present disclosure, the control circuit further includes a first insulating layer and a second conductive layer;
the first insulating layer is arranged at a side of the first conductive layer away from the first substrate; and
the second conductive layer is arranged at a side of the first insulating layer away from the first substrate, the second conductive layer includes a second connection portion, the second connection portion is connected to the drain electrode of the second transistor and the gate electrode of the third transistor through via holes, respectively.

In an embodiment of the present disclosure, the first conductive layer further includes a first connection portion connected to the gate electrode of the third transistor, and the second connection portion is connected to the first connection portion through a via hole in the first insulating layer.

In an embodiment of the present disclosure, the control circuit further includes a second insulating layer and a third conductive layer;
the second insulating layer is arranged at a side of the second conductive layer away from the first substrate; and
the third conductive layer includes a third connection portion, the third connection portion is connected to the drain electrode of the first transistor through via holes in the first insulating layer and the second insulating layer, and the third connection portion is connected to the second connection portion through a via hole in the second insulating layer.

In an embodiment of the present disclosure, the first electrode and the third conductive layer are arranged in a same layer, and the first electrode is connected to the drain electrode of the third transistor through via holes in the first insulating layer and the second insulating layer.

In an embodiment of the present disclosure, the control circuit further includes a first interlayer dielectric layer and a second interlayer dielectric layer;
the first interlayer dielectric layer is arranged between the first transistor layer and the second transistor layer; and
the second interlayer dielectric layer is arranged between the second transistor layer and the first conductive layer.

In an embodiment of the present disclosure, a barrier layer and a first buffer layer are arranged between the first substrate and the first active layer, and the barrier layer is arranged at a side of the first substrate, and the first buffer layer is arranged at a side of the barrier layer away from the first substrate.

In an embodiment of the present disclosure, the control circuit further includes a second buffer layer, and the second buffer layer is arranged between the first interlayer dielectric layer and the second interlayer dielectric layer.

In an embodiment of the present disclosure, a first planarization layer is arranged at a side of the first electrode away from the first substrate, a second planarization layer is arranged at a side of the second electrode away from the second substrate, and a spacer is arranged between the first planarization layer and the second planarization layer.

According to another aspect of the present disclosure, there is provided a method for operating the liquid crystal phase shifter according to any one of embodiments of the above aspect of the present disclosure. The method includes:
turning on the reset sub-circuit, turning off the switching sub-circuit and the driving sub-circuit, inputting a low-level Vgl signal to the reset signal line to reset the voltage of the control terminal of the driving sub-circuit;
turning off the reset sub-circuit, turning on the switching sub-circuit and the driving sub-circuit, and inputting a Vdata signal to the data signal line to turn on the driving sub-circuit;
turning off the reset sub-circuit and the switching sub-circuit, turning on the driving sub-circuit, inputting a Vdd electrical signal to the power signal line to make a capacitor formed between the first electrode and the second electrode to drive liquid crystal molecules in the liquid crystal layer to deflect.

According to another aspect of the present disclosure, there is provided an antenna. The antenna includes the liquid crystal phase shifter according to any one of embodiments of the above aspect of the present disclosure.

It should be understood that the foregoing general description and the following detailed description are exemplary and explanatory only, and do not limit the present disclosure.

### BRIEF DESCRIPTION OF THE DRAWINGS

The accompanying drawings, which are incorporated in and constitute a part of the specification, illustrate embodiments consistent with the present disclosure and together with the specification, serve to explain the principles of the present disclosure. Obviously, the drawings in the following description are only some embodiments of the present disclosure. For those of ordinary skill in the art, other drawings can be obtained based on these drawings without exerting creative efforts.

FIG. 1 is a schematic cross-sectional view of a liquid crystal phase shifter according to an embodiment of the present disclosure.

FIG. 2 is a schematic plan view of a liquid crystal phase shifter according to an embodiment of the present disclosure.

FIG. 3 is a V-phi curve of a liquid crystal phase shifter at a normal temperature according to an embodiment of the present disclosure.

FIG. 4 is a V-phi curve of a liquid crystal phase shifter at 60° C. according to an embodiment of the present disclosure.

FIG. 5 is a V-phi curve of a liquid crystal phase shifter at 90° C. according to an embodiment of the present disclosure.

FIG. 6 is a schematic circuit diagram of an adjustment unit according to an embodiment of the present disclosure.

FIG. 7 is a schematic circuit diagram of another liquid crystal phase shifter according to an embodiment of the present disclosure.

FIG. 8 is a schematic plan view of another liquid crystal phase shifter according to an embodiment of the present disclosure.

FIG. 9 is a schematic cross-sectional view of another liquid crystal phase shifter according to an embodiment of the present disclosure.

FIG. 10 is a flowchart of a method of operating another liquid crystal phase shifter according to an embodiment of the present disclosure.

FIG. 11 is a schematic diagram of the operation timing of another control circuit according to an embodiment of the present disclosure.

### LISTING OF REFERENCE NUMERALS

1—first substrate, 2—second substrate, 3—liquid crystal layer, 4—adjustment unit, 41—first electrode, 42—second electrode, 43—control circuit, 4301—driving sub-circuit, 4302—switching sub-circuit, 4303—reset sub-circuit, 4304—power signal line, 4305—data signal line, 4306—reset signal line, 4307—data signal control line, 4308—reset signal control line, 4309—reference signal line, 4310—transmission line, 431—first transistor layer, 4311—first active layer, 4312—third active portion, 4313—first gate insulating layer, 4314—first gate layer, 4315—third gate electrode, 432—second transistor layer, 4321—second active layer, 4322—first active portion, 4323—second active portion, 4324—second gate insulating layer, 4325—second gate layer, 4326—first gate electrode, 4327—second gate electrode, 433—first conductive layer, 4331—first source electrode, 4332—first drain electrode, 4333—second source electrode, 4334—second drain electrode, 4335—third source electrode, 4336—third drain electrode, 4337—first connection portion, 434—first interlayer dielectric layer, 435—second interlayer dielectric layer, 436—second conductive layer, 4361—second connection portion, 437—third conductive layer, 4371—third connection portion, 438—first insulating layer, 439—second insulating layer, 44—barrier layer, 45—first buffer layer, 46—second buffer layer, 5—first planarization layer, 6—second planarization layer, 7—spacer.

### DETAILED DESCRIPTION

Example implementations will now be described more fully with reference to the accompanying drawings. Example implementations may, however, be embodied in many forms and should not be construed as being limited to the implementations set forth herein; rather, these implementations are provided so that the present disclosure will be thorough and complete, and will fully convey the concept of example implementations to those skilled in the art. The same reference numerals in the drawings indicate the same or similar structures, and thus their detailed descriptions will be omitted. Furthermore, the drawings are merely schematic illustrations of the present disclosure and are not necessarily drawn to scale.

Although relative terms such as “upper” and “lower” are used in the specification to describe a relative relationship of one component shown in a drawing to another component, these terms are used in the specification only for convenience. For example, the terms are based on directions of examples described in the drawings. It will be understood that if a device shown in a drawing is turned upside down, a component described as “upper” would become a component which is “lower”. When a structure is “on” other structure, it may mean that the structure is integrally formed on other structure, or that the structure is “directly” arranged on other structure, or that the structure is “indirectly” arranged on other structure through another structure.

The words “one”, “a/an”, “the”, “said” and “at least one” are used in the specification to indicate the presence of one or more elements/components/etc.; the terms “comprising/comprises/comprise” and “having/has/have” are used to indicate an open-ended inclusion, and means that there may be additional elements/components/etc. in addition to the listed elements/components/etc. The words “first”, “second” and “third” are used as markers only, but are not used to limit the number of objects.

Applications in the 5G era will be greatly enriched. 5G networks need to adapt to scenarios such as large bandwidth, high reliability and low latency, or large connections. This requires 5G antennas to support more channels, to perform flexible and real-time beam adjustment, and to have an ability of supporting high-frequency band communications. A phased array antenna refers to a type of array antenna that changes the beam direction of pattern by controlling a feed phase of a radiating unit in the array antenna. The main purpose of the phased array is to achieve spatial scanning of the array beam, which is the so-called electrical scanning.

A phase shifter, as an important component of a phased array antenna, improves the power synthesis efficiency of an antenna component and the synthesis efficiency of echo signals by changing the phase consistency of the antenna component, to achieve beam switching and scanning and improve the capabilities of communication systems. A liquid crystal phase shifter inputs an applied voltage to a first electrode, causing it to overlap with a second electrode to form a capacitor, thereby changing the dielectric constant of the liquid crystal material, causing the phase constant of the electromagnetic wave on the liquid crystal phase shifter to change, and ultimately achieving the effect of adjusting the amount of phase shift. The degree of phase shift of the liquid crystal phase shifter refers to a phase difference between an input port and an output port.

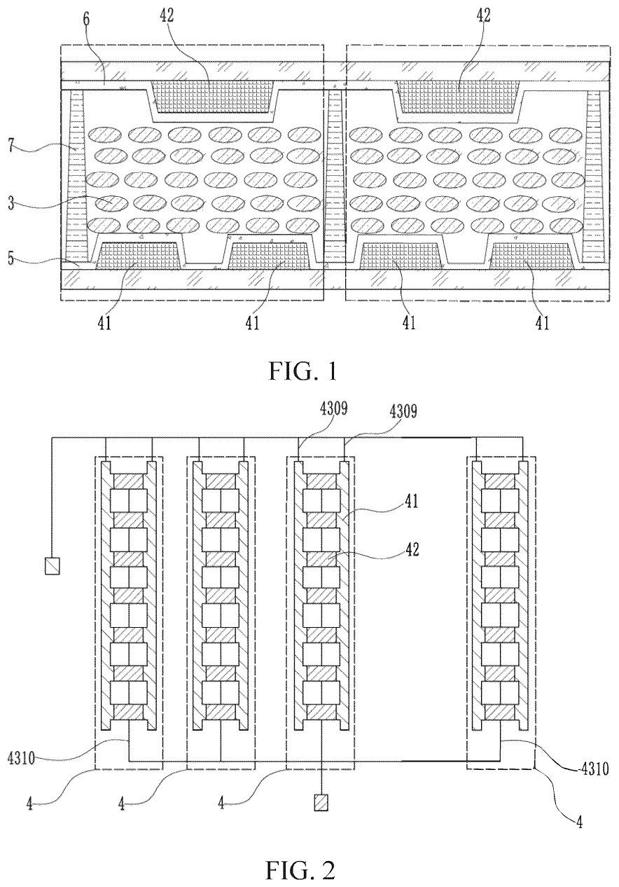

Currently, a cross-sectional schematic diagram and a plan schematic diagram of a passive liquid crystal phase shifter are as shown in FIG. 1 and FIG. 2. The liquid crystal phase shifter includes a first substrate 1 and a second substrate 2 which are arranged oppositely. At least one first electrode (transmission line electrode) 41 is arranged on a surface of the first substrate 1 close to the second substrate 2. At least one second electrode (microstrip line electrode) 42 is arranged on a surface of the second substrate 2 close to the first substrate 1. The first substrate 1 and the second substrate 2 form a cell, and a liquid crystal layer 3 is arranged between the first substrate 1 and the second substrate 2. An orthographic projection of a first electrode 41 on the first substrate 1 partially overlaps with an orthographic projection of a second electrode 42 on the first substrate 1. By applying voltages on the first electrode 41 and the second electrode 42, a capacitor is formed to cause the liquid crystal molecules in the liquid crystal layer 3 to deflect, thus changing its dielectric constant. Accordingly, the phase constant of the electromagnetic wave signal can be changed, and ultimately the amount of phase shift of the electromagnetic wave signal can be changed. Each first electrode 41 of the liquid crystal phase shifter is connected in series. The same voltage is directly applied to each first electrode 41 from a peripheral bonding pad through a transmission line 4310, and each second electrode is connected to a ground pad through a reference signal line 4309.

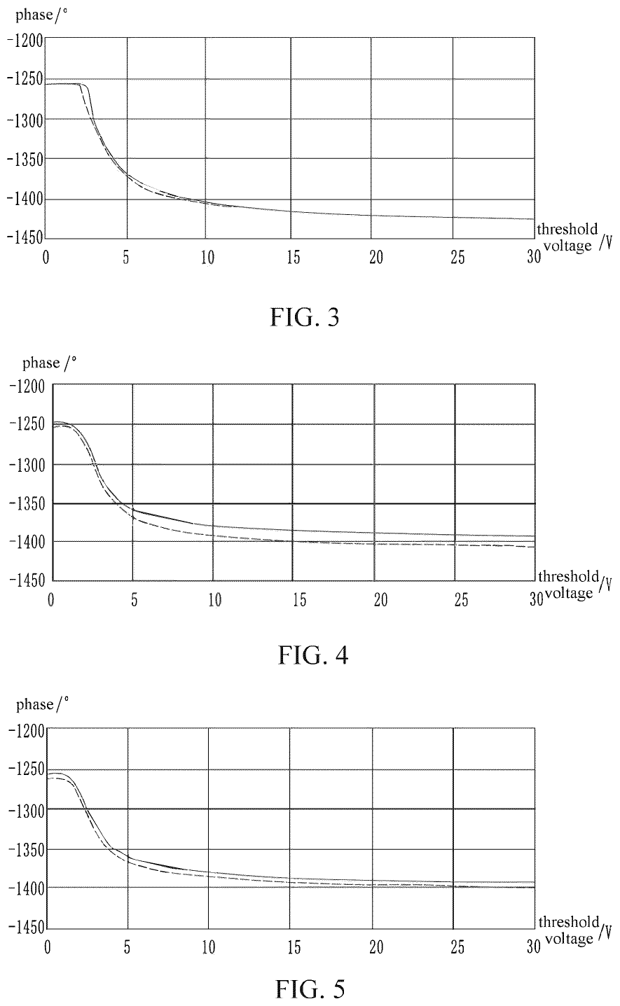

Due to the requirements of the working environment temperature, two different samples are selected from the same liquid crystal material to make two liquid crystal phase shifters. The S parameters of the two liquid crystal phase shifters are tested at normal temperature, 60° C. and 90° C. As can be seen from FIG. 3 to FIG. 5, the trends of V-Phi curves at different temperatures are roughly the same. FIG. 3 shows the V-phi curves at normal temperature, FIG. 4 shows the V-phi curves of the two different samples at 60° C., and FIG. 5 shows the V-phi curves of the two different samples at 90° C. At normal temperature, the threshold voltage is around 2V˜2.5V. In the range of 2.5V˜6V, the phase changes rapidly, exceeding 100°. In the range of 15V˜30V, the phase change is relatively small, which is within 10°. At 60° C., the threshold voltage is about 1V. The phase changes rapidly in the range of 1V˜5V, exceeding 110°. In the range of 12V˜30V, the phase change is relatively small, which is about 10°. At 90° C., the threshold voltage is about 1V. The phase changes rapidly in the range of 1V˜5V, exceeding 100°. In the range of 12V˜30V, the phase change is relatively small, which is about 10°.

It can be understood that in the procedure of adjusting the applied voltage, the set voltage which is to be applied is directly input to the first electrode(s) 41, and every time the adjustment is made on the basis of the previously applied voltage, resulting in that there is a relatively large deviation between the actual applied voltage on the first electrode(s) 41 and the set applied voltage, which leads to poor stability of the amount of phase shift of the liquid crystal. Especially, when other factor (such as temperature) affects the threshold voltage of the liquid crystal phase shifter, a greater impact will be imposed on the adjustment accuracy of the amount of phase shift. Thus, it is needed to ensure the stability of the applied voltage.

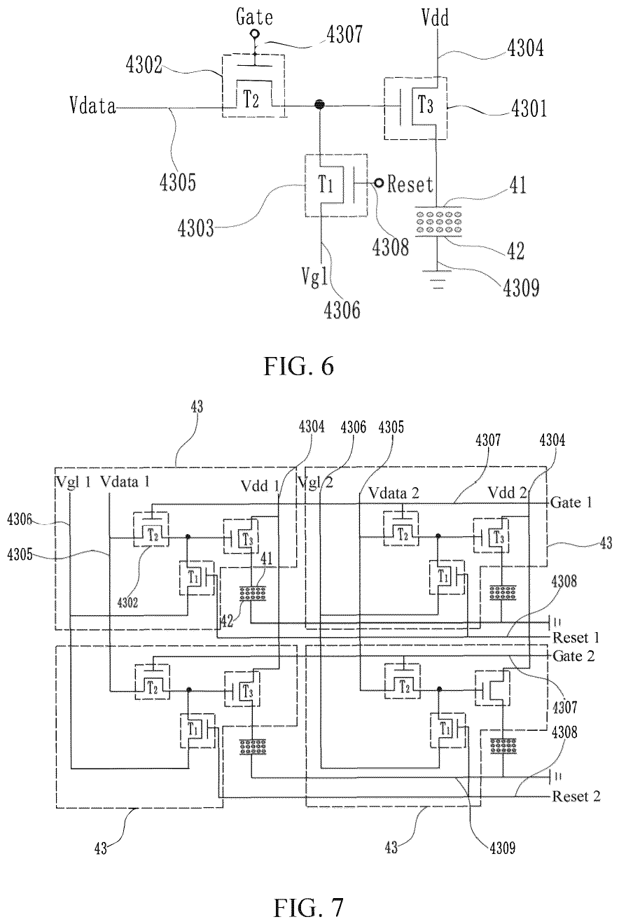

In view of the above, an embodiment of the present disclosure provides a liquid crystal phase shifter. As shown in FIGS. 6 to 9, the liquid crystal phase shifter includes a first substrate 1, a second substrate 2, a liquid crystal layer 3 and at least one adjustment unit 4. The second substrate 2 is arranged opposite to the first substrate 1. The liquid crystal layer 3 is arranged between the first substrate 1 and the second substrate 2. The adjustment unit 4 includes a first electrode 41, a second electrode 42 and a control circuit 43. The first electrode 41 is arranged at a side of the first substrate 1 close to the second substrate 2. The second electrode 42 is arranged at a side of the second substrate 2 close to the first substrate 1. The orthographic projection of the second electrode 42 on the first substrate 1 partially overlaps with the orthographic projection of the first electrode 41 on the first substrate 1. The second electrode 42 is grounded through a reference signal line 4309. The control circuit 43 is arranged between the first substrate 1 and the first electrode 41. The control circuit 43 includes a driving sub-circuit 4301, a switching sub-circuit 4302 and a reset sub-circuit 4303. The driving sub-circuit 4301 is configured to input an applied voltage to the first electrode. The switching sub-circuit 4302 is configured to control on or off of the driving sub-circuit 4301. The reset sub-circuit 4303 is configured to reset a voltage of a control terminal of the driving sub-circuit 4301.

The control terminal of the driving sub-circuit 4301 is reset through the reset sub-circuit 4303, so that every time before the driving sub-circuit 4301 is turned on, the control terminal voltage of the driving sub-circuit 4301 remains consistent. After the driving sub-circuit 4301 is turned on, the reset sub-circuit 4303 and the switching sub-circuit 4302 are turned off. During the period when the applied voltage is given to the first electrode 41, the control terminal voltage of the driving sub-circuit 4301 remains unchanged, thereby ensuring that the applied voltage on the first electrode 41 remains stable, allowing the liquid crystal phase shifter to accurately control the amount of phase shift of an electromagnetic wave signal, and thus realizing accurate beam scanning of the electromagnetic wave signal.

An input terminal of the driving sub-circuit 4301 is connected to a power signal line 4304, an output terminal of the driving sub-circuit 4301 is connected to a first electrode 41, and the control terminal of the driving sub-circuit 4301 is connected to an output terminal of the switching sub-circuit 4302. An input terminal of the switching sub-circuit 4302 is connected to a data signal line 4305, and a control terminal of the switching sub-circuit 4302 is connected to a data signal control line 4307. The control terminal of the driving sub-circuit 4301 is connected to an output terminal of the reset sub-circuit 4303, an input terminal of the reset sub-circuit 4303 is connected to a reset signal line 4306, and a control terminal of the reset sub-circuit 4303 is connected to a reset signal control line 4308.

It should be noted that the driving sub-circuit 4301 includes a third transistor T3, the input terminal of the driving sub-circuit 4301 is a source electrode of the third transistor T3, the output terminal of the driving sub-circuit 4301 is a drain electrode of the third transistor T3, and the control terminal of the driving sub-circuit 4301 is a gate electrode of the third transistor T3. The switching sub-circuit 4302 includes a second transistor T2, the input terminal of the switching sub-circuit 4302 is a source electrode of the second transistor T2, the output terminal of the switching sub-circuit 4302 is a drain electrode of the second transistor T2, and the control terminal of the switching sub-circuit 4302 are a gate electrode of the second transistor T2. The reset sub-circuit 4303 includes a first transistor T1, the input terminal of the reset sub-circuit 4303 is a source electrode of the first transistor T1, the output terminal of the reset sub-circuit 4303 is a drain electrode of the first transistor T1, and the control terminal of the reset sub-circuit 4303 is a gate electrode of the first transistor T1.

When controlling the amount of phase shift of the electromagnetic wave signal, the second transistor T2 and the third transistor T3 are turned off, and a Reset signal is input to the gate electrode of the first transistor T1 is through the reset signal control line 4308, so that the first transistor T1 is turned on; and, the Vgl signal which is set to be a low level is input to the source electrode of the first transistor T1 is through the reset signal line 4306, and is transmitted from the source electrode of the first transistor T1 to the gate electrode of the third transistor T3 to reset the gate voltage of the third transistor T3. The first transistor T1 is turned off, the Gate signal which is to be a high level is transmitted to the gate electrode of the second transistor T2 through the data signal control line 4307 in a line-by-line scanning manner, so that the second transistor T2 is turned on to transmit the Vdata signal to the source electrode of the second transistor T2 through the data signal line 4305 and the Vdata signal is transmitted from the source electrode of the second transistor T2 to the gate electrode of the third transistor T3 to control the third transistor T3 to turn on. The first transistor T1 and the second transistor T2 are turned off, the Vdd signal is input to the source electrode of the third transistor T3 through the Vdd signal line, and is transmitted from the source electrode of the third transistor T3 to the first electrode 41. Making the applied voltage on the first electrode 41 equal to the voltage of the Vdd signal can ensure the accuracy and stability of the applied voltage on the first electrode 41, allowing the liquid crystal phase shifter to accurately control the amount of phase shift of the electromagnetic wave signal, and thus achieving precise beam scanning of the electromagnetic wave signal.

The liquid crystal phase shifter involved in the present disclosure will be described in detail below with reference to example embodiments.

As shown in FIG. 6, the liquid crystal phase shifter includes at least one first electrode 41 and at least one second electrode 42. Each second electrode 42 is connected to the ground. Each first electrode 41 is controlled by a control circuit 43. The control circuit 43 includes a third transistor T3, a second transistor T2, and a first transistor T1.

The first electrode 41 is connected to the drain electrode of the third transistor T3, and the source electrode of the third transistor T3 is connected to the power signal line 4304 to input the Vdd signal to the source electrode of the third transistor T3. When the gate electrode of the third transistor T3 is turned on, the Vdd signal is transmitted to the first electrode 41. It should be noted that the Vdd signal is the applied voltage mentioned above.

The gate electrode of the third transistor T3 is connected to the drain electrode of the second transistor T2, and the source electrode of the second transistor T2 is connected to the data signal line 4305. When the second transistor T2 is turned on, the Vdata signal of the data signal line 4305 is transmitted to the gate electrode of the third transistor T3 to control the third transistor T3 to turn on. The gate electrode of the second transistor T2 is connected to the data signal control line 4307. The Gate signal is transmitted from the data signal control line 4307 to the gate electrode of the second transistor T2 in a line-by-line scanning manner to control the turning on of the second transistor T2.

The gate electrode of the third transistor T3 is connected to the drain electrode of the first transistor T1, and the source electrode of the first transistor T1 is connected to the reset signal line 4306. When the third transistor T3 is turned on, the Vgl signal is transmitted to the gate electrode of the third transistor T3 to reset the gate voltage of the third transistor T3. The gate electrode of the first transistor T1 is connected with the reset signal control line 4308. Before data signal control line 4307 for each row conducts scanning, the reset signal control line 4308 gives a Reset signal to the gate electrode of the first transistor T1, causing the first transistor T1 to turn on.

Every time before the third transistor T3 is turned on, its gate electrode is reset, so that the gate voltage of the third transistor T3 remains consistent every time before the third transistor T3 is turned on, thereby ensuring that the Vdata signal of the second transistor T2 is transmitted to the gate electrode of the third transistor T3 and the magnitude of the gate voltage of the third transistor T3 is equal to the magnitude of the Vdata signal.

After the third transistor T3 is turned on, the first transistor T1 and the second transistor T2 are turned off. During the period when the Vdd signal is applied to the first electrode 41, the gate voltage of the third transistor T3 is kept unchanged, thereby ensuring that the magnitude of the voltage on the first electrode 41 is always equal to the magnitude of the voltage of the Vdd signal. The second electrode 42 is set to be grounded, thereby ensuring that the capacitor formed by the overlapping portion of the first electrode 41 and the second electrode 42 is stable, and ultimately ensuring the stability of the amount of phase shift of the electromagnetic wave signal by the liquid crystal phase shifter.

A first electrode 41, a second electrode 42 and a control circuit 43 are defined as an adjustment unit 4. A plurality of first electrodes 41 may be provided on the first substrate 1, and a plurality of second electrodes 42 may be provided on the second substrate 2. The plurality of second electrodes 42 correspond to the plurality of first electrodes 41 one by one. A plurality control circuits 43 may be included. The drain electrode of the third transistor T3 of each control circuit 43 is respectively connected to a first electrode 41, and each second electrode 42 is connected to the ground. Therefore, the liquid crystal phase shifter may include a plurality of adjustment units 4. Each adjustment unit 4 has the same working principle. Each adjustment unit 4 may be controlled independently, but this results in that each adjustment unit 4 requires six lines, which may increase the size of the liquid crystal phase shifter and make its arrangement more difficult.

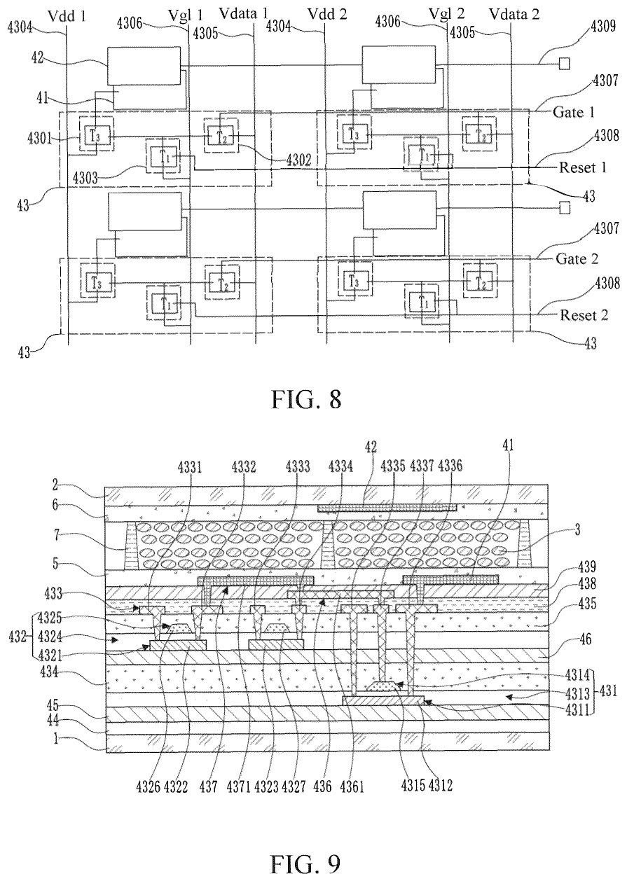

Therefore, the following arrangement and connection methods are used for multiple adjustment units 4. As shown in FIGS. 7 and 8, the liquid crystal phase shifter includes four adjustment units 4. The four adjustment units 4 may be arranged in a rectangular array, including two adjustment units 4 arranged along a row direction, and two adjustment units 4 arranged along a column direction. Gate electrodes of first transistors T1 of two control circuits 43 located in the same row are connected to the same reset signal control line 4308. Gate electrodes of second transistors T2 of two control circuits 43 located in the same row are connected to the same data signal control line 4307. Source electrodes of first transistors T1 of two control circuits 43 located in the same column are connected to the same reset signal line 4306. Source electrodes of second transistors T2 of two control circuits 43 located in the same column are connected to the same data signal line 4305. Source electrodes of third transistors T3 of two control circuits 43 located in the same column are connected to the same power signal line 4304.

The same reset signal control line 4308 controls voltages of gate electrodes of first transistors T1 of two control circuits 43 in the same row. The same data signal control line 4307 controls voltages of gate electrodes of second transistors T2 of two control circuits 43 in the same row. The same reset signal line 4306 controls voltages of source electrodes voltage of first transistors T1 of two control circuits 43 in the same column. The same data signal line 4305 controls voltages of source electrodes of second transistors T2 of two control circuits 43 in the same column. The same power signal line 4304 controls voltages of source electrodes of third transistors T3 of two control circuits 43 in the same column.

Gate electrodes of first transistors T1 of two control circuits 43 located in the first row are connected to the first reset signal control line 4308. Gate electrodes of second transistors T2 of two control circuits 43 located in the first row are connected to the first data signal control line 4307. Source electrodes of first transistors T1 of two control circuits 43 located in the first column are connected to the first reset signal line 4306. Source electrodes of second transistors T2 of two control circuits 43 located in the first column are connected to the first data signal line 4305. Source electrodes of third transistors T3 of two control circuits 43 located in the first column are connected to the first power signal line 4304.

Gate electrodes of first transistors T1 of two control circuits 43 located in the second row are connected to the Reset2 signal line. Gate electrodes of second transistors T2 of two control circuits 43 located in the second row are connected to the Gate2 line. Source electrodes of first transistors T1 of two control circuits 43 located in the second column are connected to the Vgl2 signal line. Source electrodes of second transistors T2 of two control circuits 43 located in the second column are connected to the Vdata2 signal line. Source electrodes of third transistors T3 of two control circuits 43 in the second column are connected to the Vdd2 signal line.

It can be understood that the first reset signal control line 4308 is used to input the Reset1 signal to control the voltages of the gate electrodes of the first transistors T1 of the two control circuits 43 in the first row. The first data signal control line 4307 is used to input the Gate1 signal to control the voltages of the gate electrodes of the second transistors T2 of the two control circuits 43 in the first row. The first reset signal line 4306 is used to input the Vgl1 signal to control the voltages of the source electrodes of the first transistors T1 of the two control circuits 43 in the first column. The first data signal line 4305 is used to input the Vdata1 signal to control the voltages of the source electrodes of the second transistors T2 of the two control circuits 43 in the first column. The first power signal line 4304 is used to input the Vdd1 signal to control the voltages of the source electrodes of the third transistors T3 of the two control circuits 43 in the first column.

The second reset signal control line 4308 is used to input the Reset2 signal to control the voltages of the gate electrodes of the first transistors T1 of the two control circuits 43 in the second row. The second data signal control line 4307 is used to input the Gate2 signal to control the voltages of the gate electrodes of the second transistors T2 of the two control circuits 43 in the second row. The second reset signal line 4306 is used to input the Vgl2 signal to control the voltages of the source electrodes of the first transistors T1 of the two control circuits 43 in the second column. The second data signal line 4305 is used to input the Vdata2 signal to control the voltages of the source electrodes of the second transistors T2 of the two control circuits in the second column. The second power signal line 4304 is used to input the Vdd2 signal to control the voltages of the source electrodes of the third transistors T3 of the two control circuits 43 in the second column.

The liquid crystal phase shifter involved in FIG. 1 requires uniform adjustment of the applied voltage on each first electrode 41, which requires large power consumption. Small changes in the applied voltage will have a greater impact on the amount of phase shift of the electromagnetic wave signal. When the required adjustment amplitude of the amount of phase shift is small, the liquid crystal phase shifter can only reduce the change amount of the applied voltage. Even if the change amount of the applied voltage is set to the minimum, it will cause a relatively large change in the amount of phase shift of the electromagnetic wave signal, and the adjustment accuracy is limited.

The liquid crystal phase shifter involved in the embodiments of the present disclosure can adjust the applied voltages of the plurality of first electrodes 41 respectively, and can reduce the power consumption generated during the adjustment procedure. The adjustment of the amount of phase shift of the electromagnetic wave signal is realized by the composite action of respective adjustment units 4. By setting the number of adjustment units 4, the amount of phase shift of the electromagnetic wave signal can be adjusted; by changing the applied voltage of a single adjustment unit 4, the amount of phase shift of the electromagnetic wave signal can also be adjusted.

In the actual adjustment procedure, setting of the number of adjustment units 4 or changing of the applied voltage of a single adjustment unit 4 can be performed separately, or the number of adjustment units 4 and the applied voltage(s) of the adjustment unit(s) 4 can be changed at the same time, thereby ensuring accurate control of the amount of phase shift of the electromagnetic wave signal by the liquid crystal phase shifter, and achieving precise beam scanning of the electromagnetic wave signal. This can improve the adjustment accuracy of the amount of phase shift of the electromagnetic wave signal, and further improve the beam scanning accuracy of the electromagnetic wave signal by the entire liquid crystal phase shifter.

The specific structure of the liquid crystal phase shifter will be described below. As shown in FIG. 9, the liquid crystal phase shifter includes a first substrate 1 and a second substrate 2. The first substrate 1 and the second substrate 2 are arranged to form a cell, and the liquid crystal layer 3 is arranged between the first substrate 1 and the second substrate 2. At least one first electrode 41 is arranged on a surface of the first substrate 1 facing the second substrate 2. At least one second electrode 42 is arranged on a surface of the second substrate 2 facing the first substrate 1. An orthographic projection of a first electrode 41 on the first substrate 1 partially overlaps with an orthographic projection of a second electrode 42 on the first substrate 1. A first planarization layer 5 is arranged at a side of the first electrode 41 away from the first substrate 1, and a second planarization layer 6 is arranged at a side of the second electrode 42 away from the second substrate 2. A plurality of spacers 7 are arranged between the first planarization layer 5 and the second planarization layer 6, so that an accommodating cavity is formed between the second substrate 2 and the first substrate 1, and the accommodating cavity is filled with liquid crystal molecules to form the liquid crystal layer 3.

A control circuit 43 is arranged between the first substrate 1 and a first electrode 41. The control circuit 43 includes a first transistor T1, a second transistor T2, and a third transistor T3. All of the first transistor T1, the second transistor T2, and the third transistor T3 may be thin film transistors. Therefore, the control circuit 43 may include a first transistor layer 431, a second transistor layer 432, and a first conductive layer 433. The first transistor layer 431 is arranged at a side of the first substrate 1. The second transistor layer 432 is arranged at a side of the first transistor layer 431 away from the first substrate 1. The first conductive layer 433 is arranged at a side of the second transistor layer 432 away from the first substrate 1. A first interlayer dielectric layer 434 is arranged between the first transistor layer 431 and the second transistor layer 432. A second interlayer dielectric layer 435 is arranged between the second transistor layer 432 and the first conductive layer 433.

The control circuit 43 further includes a barrier layer 44, a first buffer layer 45 and a second buffer layer 46. The barrier layer 44 and the first buffer layer 45 are arranged between the first substrate 1 and a first active layer 4311. The barrier layer 44 is arranged at a side of the first substrate 1, the first buffer layer 45 is arranged at a side of the barrier layer 44 away from the first substrate 1, and the second buffer layer 46 is arranged between the first interlayer dielectric layer 434 and the second transistor layer 432.

The first transistor layer 431 includes the first active layer 4311, a first gate insulating layer 4313 and a first gate layer 4314. The first active layer 4311 is arranged at a side of the first buffer layer 45 away from the first substrate 1. The gate insulating layer 4313 is arranged at a side of the first active layer 4311 away from the first substrate 1. The first gate layer 4314 is arranged at a side of the first gate insulating layer 4313 away from the first substrate 1. The second transistor layer 432 includes a second active layer 4321, a second gate insulating layer 4324 and the second gate layer 4325. The second active layer 4321 is arranged at a side of the second buffer layer 46 away from the first substrate 1. The second gate insulating layer 4324 is arranged at a side of the second active layer 4321 away from the first substrate 1. The second gate layer 4325 is arranged at a side of the second gate insulating layer 4324 away from the first substrate 1.

The first active layer 4311 includes a third active portion 4312. The third active portion 4312 is the active portion of the third transistor T3. The first gate layer 4314 includes a third gate electrode 4315. The third gate electrode 4315 is the gate electrode of the third transistor T3. The second active layer 4321 includes a first active portion 4322 and a second active portion 4323. The first active portion 4322 is the active portion of the first transistor T1. The second active portion 4323 is the active portion of the second transistor T2. The second gate layer 4325 includes a first gate electrode 4326 and a second gate electrode 4327. The first gate electrode 4326 is the gate electrode of the first transistor T1. The second gate electrode 4327 is the gate electrode of the second transistor T2. The first conductive layer 433 includes a first source electrode 4331, a first drain electrode 4332, a second source electrode 4333, a second drain electrode 4334, a third source electrode 4335 and a third drain electrode 4336. The first source electrode 4331 and the first drain electrode 4332 are the source electrode and drain electrode of the first transistor T1. The second source electrode 4333 and the second drain electrode 4334 are the source electrode and the drain electrode of the second transistor T2. The third source electrode 4335 and the third drain electrode 4336 are the source electrode and drain electrode of the third transistor T3.

The third source electrode 4335 and the third drain electrode 4336 are connected to the third active portion 4312 through via holes in the second interlayer dielectric layer 435, via holes in the second gate insulating layer 4324, via holes in the first buffer layer 45, and via holes in the first interlayer dielectric layer 435 in sequence. The first source electrode 4331 and the first drain electrode 4332 are connected to the first active portion 4322 through via holes in the second interlayer dielectric layer 435 and via holes in the second gate insulating layer 4324 in sequence. The second source electrode 4333 and the second drain electrode 4334 are connected to the second active portion 4323 through via holes in the second interlayer dielectric layer 435 and via holes in the second gate insulating layer 4324 in sequence.

In the control circuit 43, the first active portion 4322 and the second active portion 4323 employ IGZO oxide, so that when the first transistor T1 and the second transistor T2 are turned off, the off-current (I_{off} current) is relatively small. This ensures the stability of the gate voltage on the third transistor T3, thereby ensuring the stability of the Vdd signal transmitted to the first electrode 41, and thus ensuring the stability of the amount of phase shift of the liquid crystal phase shifter. The active portion of the third transistor T3 is made of low-temperature polysilicon, so that the mobility of the third transistor T3 is relatively high, which can ensure that the electrical signal transmitted from the Vdd signal to the first electrode 41 remains stable, thereby ensuring that the amount of phase shift of the electrical signal is kept stable.

The first source electrode 4331 and the first drain electrode 4332, the second source electrode 4333 and the second drain electrode 4334, and the third source electrode 4335 and the third drain electrode 4336 are all located in the first conductive layer 433 and can be formed at once through one set of mask components, and the production cost is low.

The control circuit 43 further includes a first insulating layer 438 and a second conductive layer 436. The first insulating layer 438 is arranged at a side of the first conductive layer 433 away from the first substrate 1. The second conductive layer 436 is arranged at a side of the first insulating layer 438 away from the first substrate 1. The second conductive layer 436 includes a second connection portion 4361. The second connection portion 4361 is respectively connected to the drain electrode of the second transistor T2 and the gate electrode of the third transistor T3 through via holes.

The second conductive layer 436 may be connected to the active portion of the third transistor T3 directly through a via hole in the first insulating layer 438, a via hole in the second interlayer dielectric layer 435, a via hole in the second gate insulating layer 4324, a via hole in the first buffer layer 45 and a via hole in the first interlayer dielectric layer 434. However, since the second conductive layer 436 passes through a large number of layers, the second conductive layer 436 may not be able to extend to the active portion of the third transistor T3, or the second conductive layer 436 may be disconnected in via hole(s).

Therefore, the first conductive layer 433 may further include a first connection portion 4337. The first connection portion 4337 is connected to the gate electrode of the third transistor T3 through a via hole in the second interlayer dielectric layer 435, a via hole in the second gate insulating layer 4324, a via hole in the first buffer layer 45 and a via hole in the first interlayer dielectric layer 434. The second connection portion 4361 is connected to the first connection portion 4337 through a via hole in the first insulating layer 438. The first connection portion 4337 passes through a relatively small number of layers and can extend to the active portion of the third transistor T3, while the second connection portion 4361 only needs to pass through the first insulating layer 438. The first connection portion 4337 is located in the first conductive layer 433 and can be formed at once with the source electrode and drain electrode of the first transistor T1, the source electrode and drain electrode of the second transistor T2, and the source electrode and drain electrode of the third transistor T3, and the process cost is lower.

The control circuit 43 further includes a second insulating layer 439 and a third conductive layer 437. The second insulating layer 439 is arranged at a side of the second conductive layer 436 away from the first substrate 1. The third conductive layer 437 includes a third connection portion 4371. The third connection portion 4371 is connected to the drain electrode of the first transistor T1 through via holes in the first insulating layer 438 and the second insulating layer 439. The third connection portion 4371 is connected to the second connection portion 4361 through a via hole in the second insulating layer 439.

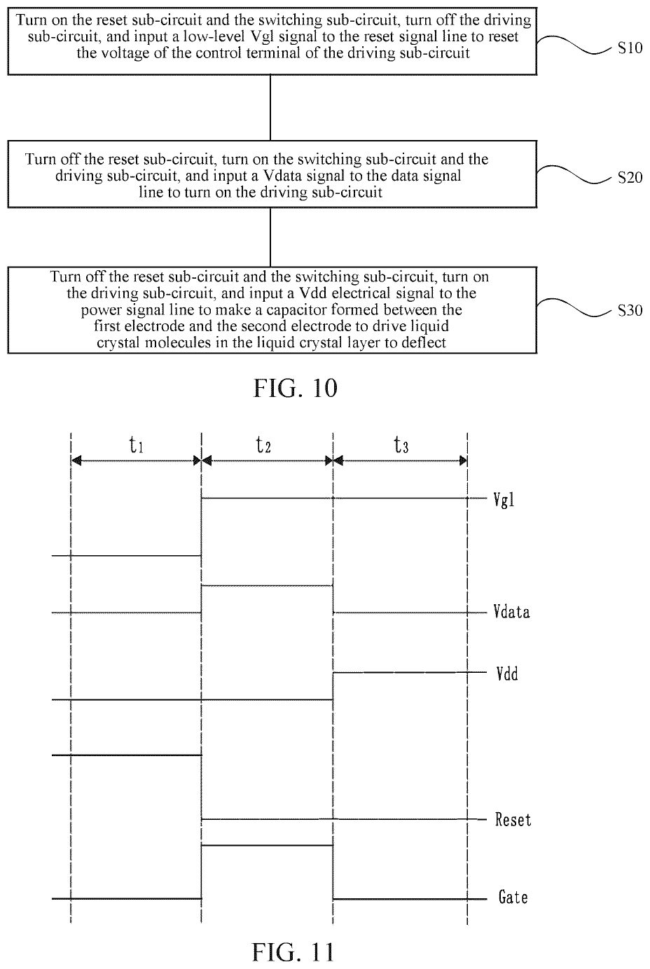

An embodiment of the present disclosure further provides a method for operating a liquid crystal phase shifter. The method may include steps shown in FIG. 10. Referring to FIGS. 6 to 9 based on FIGS. 10 and 11, the method may include the following steps.

In step S10, in a first stage t1: the reset sub-circuit 4303 is turned on, the switching sub-circuit 4302 and the driving sub-circuit 4301 are turned off, and a low-level Vgl signal is input to the reset signal line 4306 to reset the voltage of the control terminal of the driving sub-circuit 4301.

In the first stage t1, a high-level Reset signal is input to the control terminal of the reset sub-circuit 4303 through the reset signal control line 4308 to turn on the reset sub-circuit 4303.

In step S20, in a second stage t2: the reset sub-circuit 4303 is turned off, the switching sub-circuit 4302 and the driving sub-circuit 4301 are turned on, and the Vdata signal is input to the data signal line 4305 to turn on the driving sub-circuit 4301.

A high-level Gate signal is input to the control terminal of the switching sub-circuit 4302 through the data signal control line to turn on the switching sub-circuit 4302. A high-level Vdata signal is input to the control terminal of the driving sub-circuit 4301 to turn on the driving sub-circuit 4301.

In step S30, in a third stage t3: the reset sub-circuit 4303 and the switching sub-circuit 4302 are turned off, the driving sub-circuit 4301 is turned on, and the Vdd electrical signal is input to the power signal line 4304, so that a capacitor is formed between a first electrode 41 and a second electrode 42 to drive the liquid crystal molecules in the liquid crystal layer 3 to deflect.

The Vdd electrical signal is transmitted to the first electrode 41 through the output terminal of the driving sub-circuit 4301.

During the period when the Vdd signal is applied to the first electrode 41, the gate voltage of the third transistor T3 remains unchanged, thereby ensuring that the voltage on the first electrode 41 always remains stable, so that the liquid crystal phase shifter can accurately control the amount of phase shift of the electromagnetic wave signal, and thus precise beam scanning of the electromagnetic wave signal can be achieved.

It should be noted that when a high-level Reset signal is input to the reset signal control line 4308, the first transistor T1 is turned on. When a low-level Reset signal is input to the reset signal control line 4308, the first transistor T1 is turned off. When a high-level Gate signal is input to the data signal control line 4307, the second transistor T2 is turned on. When a low-level Gate signal is input to the data signal control line 4307, the second transistor T2 is turned off. When a high-level Vdata signal is input to the data signal line 4305, the third transistor T3 is turned on. When a low-level Vdata signal is input to the data signal line 4305, the third transistor T3 is turned off.

An embodiment of the present disclosure provides an antenna. The antenna may include a liquid crystal phase shifter according to any one of the above described embodiments. For the beneficial effects of the antenna, reference can be made to the beneficial effects of the liquid crystal phase shifter, which will not be described in detail here.

Other embodiments of the present disclosure will be readily apparent to those skilled in the art from consideration of the specification and practice of the invention disclosed herein. The present disclosure is intended to cover any variations, uses, or adaptations of the present disclosure that follow the general principles of the present disclosure and include common knowledge or customary technical means in the technical field that are not disclosed in the present disclosure. It is intended that the specification and embodiments be considered as exemplary only, with a true scope and spirit of the present disclosure being indicated by the appended claims.

What is claimed is:

1. A liquid crystal phase shifter, comprising:
a first substrate;
a second substrate arranged opposite to the first substrate;
a liquid crystal layer arranged between the first substrate and the second substrate; and
at least one adjustment unit;
wherein:
one of the at least one adjustment unit comprises a first electrode, a second electrode and a control circuit;
the first electrode is arranged at a side of the first substrate close to the second substrate;
the second electrode is arranged at a side of the second substrate close to the first substrate;
an orthographic projection of the second electrode on the first substrate partially overlaps an orthographic projection of the first electrode on the first substrate, and the second electrode is grounded;
the control circuit is arranged between the first substrate and the first electrode, and the control circuit comprises a driving sub-circuit, a switching sub-circuit and a reset sub-circuit; and
the driving sub-circuit is configured to input a voltage to the first electrode, the switching sub-circuit is configured to control on or off of the driving sub-circuit, and the reset sub-circuit is configured reset a voltage of a control terminal of the driving sub-circuit.

2. The liquid crystal phase shifter according to claim 1, wherein:
an input terminal of the driving sub-circuit is connected to a power signal line, an output terminal of the driving sub-circuit is connected to the first electrode, and the control terminal of the driving sub-circuit is connected to an output terminal of the switching sub-circuit;
an input terminal of the switching sub-circuit is connected to a data signal line, a control terminal of the switching sub-circuit is connected to a data signal control line; and
the control terminal of the driving sub-circuit is connected to an output terminal of the reset sub-circuit, an input terminal of the reset sub-circuit is connected to a reset signal line, and a control terminal of the reset sub-circuit is connected to a reset signal control line.

3. The liquid crystal phase shifter according to claim 2, wherein the at least one adjustment unit comprises a plurality of the adjustment units.

4. The liquid crystal phase shifter according to claim 2, wherein:
the driving sub-circuit comprises a third transistor, the input terminal of the driving sub-circuit is a source electrode of the third transistor, the output terminal of the driving sub-circuit is a drain electrode of the third transistor, and the control terminal of the driving sub-circuit is a gate electrode of the third transistor;
the switching sub-circuit comprises a second transistor, the input terminal of the switching sub-circuit is a source electrode of the second transistor, the output terminal of the switching sub-circuit is a drain electrode of the second transistor, and the control terminal of the switching sub-circuit is a gate electrode of the second transistor; and
the reset sub-circuit comprises a first transistor, the input terminal of the reset sub-circuit is a source electrode of the first transistor, the output terminal of the reset sub-circuit is a drain electrode of the first transistor, and the control terminal of the reset sub-circuit is a gate electrode of the first transistor.

5. The liquid crystal phase shifter according to claim 4, wherein:
the plurality of the adjustment units are arranged in a rectangular array;
gate electrodes of first transistors of two control circuits located in a same row are connected to a same reset signal control line;
gate electrodes of second transistors of two control circuits located in a same row are connected to a same data signal control line;
source electrodes of first transistors of two control circuits located in a same column are connected to a same reset signal line;
source electrodes of second transistors of two control circuits located in a same column are connected to a same data signal line; and
source electrodes of third transistors of two control circuits located in a same column are connected to a same power signal line.

6. The liquid crystal phase shifter according to claim 4, wherein a material of an active portion of the third transistor is low-temperature polysilicon, and materials of an active portion of the first transistor and an active portion of the second transistor are Indium Gallium Zinc Oxide (IGZO).

7. The liquid crystal phase shifter according to claim 4, wherein the control circuit comprises:
a first transistor layer arranged at a side of the first substrate, wherein the first transistor layer comprises a first active layer, a first gate insulating layer and a first gate layer sequentially arranged in a direction away from the first substrate, the first active layer comprises an active portion of the third transistor, and the first gate layer comprises the gate electrode of the third transistor; and
a second transistor layer arranged at a side of the first transistor layer away from the first substrate, wherein the second transistor layer comprises a second active layer, a second gate insulating layer and a second gate layer, the second active layer comprises an active portion of the first transistor and an active portion of the second transistor, and the second gate layer comprises the gate electrode of the first transistor and the gate electrode of the second transistor.

8. The liquid crystal phase shifter according to claim 7, wherein the control circuit further comprises a first conductive layer, the first conductive layer is arranged at a side of the second transistor layer away from the first substrate, the first conductive layer comprises the source electrode and the drain electrode of the first transistor, the source electrode and the drain electrode of the second transistor, and the source electrode and the drain electrode of the third transistor.

9. The liquid crystal phase shifter according to claim 8, wherein the control circuit further comprises:
a first insulating layer arranged at a side of the first conductive layer away from the first substrate; and
a second conductive layer arranged at a side of the first insulating layer away from the first substrate, wherein the second conductive layer comprises a second connection portion, the second connection portion is connected to the drain electrode of the second transistor and the gate electrode of the third transistor through via holes, respectively.

10. The liquid crystal phase shifter according to claim 9, wherein the first conductive layer further comprises a first connection portion connected to the gate electrode of the third transistor, and the second connection portion is connected to the first connection portion through a via hole in the first insulating layer.

11. The liquid crystal phase shifter according to claim 10, wherein the control circuit further comprises:
a second insulating layer arranged at a side of the second conductive layer away from the first substrate; and
a third conductive layer comprising a third connection portion, wherein the third connection portion is connected to the drain electrode of the first transistor through via holes in the first insulating layer and the second insulating layer, and the third connection portion is connected to the second connection portion through a via hole in the second insulating layer.

12. The liquid crystal phase shifter according to claim 11, wherein the first electrode and the third conductive layer are arranged in a same layer, and the first electrode is connected to the drain electrode of the third transistor through via holes in the first insulating layer and the second insulating layer.

13. The liquid crystal phase shifter according to claim 8, wherein the control circuit further comprises:
a first interlayer dielectric layer arranged between the first transistor layer and the second transistor layer; and
a second interlayer dielectric layer arranged between the second transistor layer and the first conductive layer.

14. The liquid crystal phase shifter according to claim 13, wherein a barrier layer and a first buffer layer are arranged between the first substrate and the first active layer, and the barrier layer is arranged at a side of the first substrate, and the first buffer layer is arranged at a side of the barrier layer away from the first substrate.

15. The liquid crystal phase shifter according to claim 14, wherein the control circuit further comprises a second buffer layer, and the second buffer layer is arranged between the first interlayer dielectric layer and the second interlayer dielectric layer.

16. The liquid crystal phase shifter according to claim 1, wherein a first planarization layer is arranged at a side of the first electrode away from the first substrate, a second planarization layer is arranged at a side of the second electrode away from the second substrate, and a spacer is arranged between the first planarization layer and the second planarization layer.

17. A method for operating a liquid crystal phase shifter,
wherein the liquid crystal phase shifter comprises:
a first substrate;
a second substrate arranged opposite to the first substrate;
a liquid crystal layer arranged between the first substrate and the second substrate; and
at least one adjustment unit,
wherein:
one of the at least one adjustment unit comprises a first electrode, a second electrode and a control circuit;
the first electrode is arranged at a side of the first substrate close to the second substrate;
the second electrode is arranged at a side of the second substrate close to the first substrate;
an orthographic projection of the second electrode on the first substrate partially overlaps an orthographic projection of the first electrode on the first substrate, and the second electrode is grounded;
the control circuit is arranged between the first substrate and the first electrode, and the control circuit comprises a driving sub-circuit, a switching sub-circuit and a reset sub-circuit; and
the driving sub-circuit is configured to input a voltage to the first electrode, the switching sub-circuit is configured to control on or off of the driving sub-circuit, and the reset sub-circuit is configured reset a voltage of a control terminal of the driving sub-circuit;
wherein the method comprises:
turning on the reset sub-circuit, turning off the switching sub-circuit and the driving sub-circuit, and inputting a low-level signal to a reset signal line which is connected to an input terminal of the reset sub-circuit to reset the voltage of the control terminal of the driving sub-circuit;
turning off the reset sub-circuit, turning on the switching sub-circuit and the driving sub-circuit, and inputting a signal to a data signal line which is connected to an input terminal of the switching sub-circuit to transmit the signal to the control terminal of the driving sub-circuit to turn on the driving sub-circuit; and
turning off the reset sub-circuit and the switching sub-circuit, and inputting a signal to a power signal line which is connected to the driving sub-circuit to apply the voltage to the first electrode through the driving sub-circuit.

18. An antenna, comprising a liquid crystal phase shifter;
wherein the liquid crystal phase shifter comprises:
a first substrate;
a second substrate arranged opposite to the first substrate;
a liquid crystal layer arranged between the first substrate and the second substrate; and
at least one adjustment unit,
wherein:
one of the at least one adjustment unit comprises a first electrode, a second electrode and a control circuit;
the first electrode is arranged at a side of the first substrate close to the second substrate;
the second electrode is arranged at a side of the second substrate close to the first substrate;
an orthographic projection of the second electrode on the first substrate partially overlaps an orthographic projection of the first electrode on the first substrate, and the second electrode is grounded;
the control circuit is arranged between the first substrate and the first electrode, and the control circuit comprises a driving sub-circuit, a switching sub-circuit and a reset sub-circuit; and
the driving sub-circuit is configured to input a voltage to the first electrode, the switching sub-circuit is configured to control on or off of the driving sub-circuit, and the reset sub-circuit is configured reset a voltage of a control terminal of the driving sub-circuit.

19. The antenna according to claim 18, wherein:
an input terminal of the driving sub-circuit is connected to a power signal line, an output terminal of the driving sub-circuit is connected to the first electrode, and the control terminal of the driving sub-circuit is connected to an output terminal of the switching sub-circuit;
an input terminal of the switching sub-circuit is connected to a data signal line, a control terminal of the switching sub-circuit is connected to a data signal control line; and
the control terminal of the driving sub-circuit is connected to an output terminal of the reset sub-circuit, an input terminal of the reset sub-circuit is connected to a reset signal line, and a control terminal of the reset sub-circuit is connected to a reset signal control line.

20. The antenna according to claim 19, wherein:
the driving sub-circuit comprises a third transistor, the input terminal of the driving sub-circuit is a source electrode of the third transistor, the output terminal of the driving sub-circuit is a drain electrode of the third transistor, and the control terminal of the driving sub-circuit is a gate electrode of the third transistor;
the switching sub-circuit comprises a second transistor, the input terminal of the switching sub-circuit is a source electrode of the second transistor, the output terminal of the switching sub-circuit is a drain electrode of the second transistor, and the control terminal of the switching sub-circuit is a gate electrode of the second transistor; and
the reset sub-circuit comprises a first transistor, the input terminal of the reset sub-circuit is a source electrode of the first transistor, the output terminal of the reset sub-circuit is a drain electrode of the first transistor, and the control terminal of the reset sub-circuit is a gate electrode of the first transistor.
